(19) United States
(12) Patent Application Publication
(10) Pub. No.: US 2025/0346434 A1
(43) Pub. Date: Nov. 13, 2025

(54) CONVEYOR BELT INSERT FOR A WEAR MONITORING SYSTEM

(71) Applicant: Fenner Dunlop Americas, LLC, Pittsburgh, PA (US)

(72) Inventors: Douglas C. Nason, Fremont, OH (US); George Mark Myers, Bland, VA (US); Matthew Edward Basil Adkins, Princeton, WV (US)

(21) Appl. No.: 19/202,771

(22) Filed: May 8, 2025

Related U.S. Application Data
(60) Provisional application No. 63/643,998, filed on May 8, 2024.

(51) Int. Cl. B65G 43/02; B65G 15/32

(52) U.S. Cl. CPC B65G 43/02; B65G 15/32; B65G 2203/0275; B65G 2207/48

(57) ABSTRACT

A conveyor belt insert for a wear monitoring system configured to detect and indicate wear of a conveyor belt, in particular a location and extent of a surface wear. The wear monitoring system monitors the conveyor belt for the surface wear without interruption to working operations. The wear monitoring system comprises the conveyor belt insert, integrated with the conveyor belt and comprised of one or more reflectors embedded therein; a sensing assembly comprised of one or more sensing pairs including one or more transmitters and one or more receivers; and at least one controller configured to monitor an intensity of at least one signal provided from the transmitters to the receivers to determine the surface wear of the conveyor belt.

### CROSS-REFERENCE TO RELATED APPLICATION

This application claims the benefit of U.S. Provisional Patent Application Ser. No. 63/643,998, filed May 8, 2024, the entirety of which is herein incorporated by reference.

### FIELD

The invention relates to a system for monitoring wear, and more particularly to a conveyor belt insert for a wear monitoring system.

### BACKGROUND

Conveyor belts and conveyor systems are widely used in the transport of a variety of materials and products. Conveyor belts may be used in light or heavy materials transport. For heavy materials transport, the conveyor belts often have reinforcing cords of steel or other material embedded in the belt to provide additional tensile strength. For lighter material transport, such reinforcing cords may be formed of lighter weight non-metallic fibers or cords. In some applications, no reinforcing cords are used.

Conveyor belt wear can arise during the operation of these belt systems. Wear to the conveyor belt, specifically the surface of the conveyor belt which comes into contact with the material being transported, over a period of time, can result in the weakening of the strength of the belt, opening up the conveyor belt to the risk of damage or even destruction during operation. Such a condition can render the belt unsuitable for the continued transport of material so that the belt must be taken out of service. In extreme cases, the entire belt may require replacement. In other cases, only the damaged section must be repaired. As will be appreciated, this can result in substantial financial losses due to the cost of belt repair or replacement, as well as the costly suspension of manufacturing or other operations that rely on continued operation of the conveyor system.

It would therefore be desirable to produce a conveyor belt insert for a wear monitoring system that is able to detect surface wear of the conveyor belt, a location of said surface wear, and an extent of the wear damage.

### SUMMARY

In concordance and agreement with the present disclosure, a conveyor belt insert for a wear monitoring system that is able to detect surface wear of the conveyor belt, a location of said surface wear, and an extent of the wear damage, has surprisingly been designed.

A conveyor belt monitoring system of the present disclosure does not interrupt the operation of the conveyor belt, allowing the system to continuously monitor the conveyor belt for surface wear without interruption to working operations.

In one embodiment, a conveyor belt insert, comprises: at least one layer; and a plurality of reflectors disposed in the at least one layer, wherein the reflectors are configured to alter a signal transmitted from a monitoring system configured to detect surface wear of a conveyor belt, and wherein the reflectors are disposed at various depths within the at least one layer relative to an outer surface of the conveyor belt.

In another embodiment, a wear monitoring system for a conveyor belt, comprises: at least one target portion provide with the conveyor belt, wherein the target portion includes at least one layer having one or more reflectors disposed at various depths within the at least one layer relative to an outer surface of the conveyor belt; and a sensing assembly disposed adjacent to the at least one target portion, wherein the wear monitoring system is configured to detect surface wear of the conveyor belt.

In yet another embodiment, a method of monitoring surface wear of a conveyor belt, comprises: providing a wear monitoring system comprising at least one target portion provided with the conveyor belt and a sensing system, wherein the sensing system comprises at least one sensing pair including at least one transmitter and at least one receiver; emitting one or more signals from the at least one transmitter; receiving by the at least one receiver the one or more signals from the at least one transmitter; and determining a surface wear of the conveyor belt based upon an intensity of the one or more signals.

As aspects of some embodiments, the reflectors are produced from a radio frequency absorbent material and/or a reflective material.

As aspects of some embodiments, the reflectors are produced from a copper mesh fabric.

As aspects of some embodiments, the reflectors span at least partially across a width of the conveyor belt.

As aspects of some embodiments, at least a portion of the reflectors are arranged in a linear configuration to form one or more reflective strips.

As aspects of some embodiments, each of the reflective strips are spaced apart from an adjacent one of the reflective strips.

As aspects of some embodiments, at least a portion of at least one or the reflective strips may be perforated and/or cut across a width thereof in segmented intervals.

As aspects of some embodiments, at least one of the reflective strips is comprised of a linear array of spaced apart reflectors.

As aspects of some embodiments, the reflective strips are vertically spaced apart from one another within the at least one layer.

As aspects of some embodiments, a generally constant intensity of a signal emitted by the sensing assembly indicates surface wear of the conveyor belt.

As aspects of some embodiments, a decrease in intensity of a signal emitted by the sensing assembly indicates a presence of the one or more reflectors.

As aspects of some embodiments, the at least one target portion includes at least two reflective strips formed by the one or more reflectors.

As aspects of some embodiments, at least two target portions are provided with the conveyor belt.

As aspects of some embodiments, the sensing assembly includes one or more sensing pairs, each of the sensing pairs including at least one transmitter and at least one receiver.

As aspects of some embodiments, the at least one transmitter is disposed adjacent an outer surface of the conveyor belt.

As aspects of some embodiments, the at least one receiver is disposed adjacent the conveyor belt opposite the at least one transmitter.

As aspects of some embodiments, the at least one transmitter is configured to emit one or more signals and the at least one receiver is configured to receive the one or more signals emitted by the transmitter.

As aspects of some embodiments, the one or more sensing pairs are radio frequency pairs comprised of at least one radio frequency transmitter and at least one radio frequency receiver.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic perspective view, partially in section, of a wear monitoring system for a conveyor belt according to an embodiment of the present disclosure, wherein the wear monitoring system includes a target portion and a sensing assembly;

FIG. 2 is a top plan view of a conveyor belt provided with a target portion including three embedded reflector strips according to an embodiment of the present disclosure;

FIG. 3 is a top plan view of a target portion including three perforated reflective strips according to an embodiment of the present disclosure;

FIG. 4 is a cross-sectional view of a target portion of a conveyor belt having three reflector strips embedded at various depths according to an embodiment of the present disclosure;

FIG. 5 is a cross-sectional view of a target portion of a conveyor belt having three reflector strips embedded at various depths according to another embodiment of the present disclosure;

FIG. 6 is a front elevational view of a sensing assembly provided with a mounting structure according to an embodiment of the present disclosure, wherein the sensing assembly shown comprises four sensing pairs;

FIG. 7 is a top plan view of a wear monitoring system for a conveyor belt according to an embodiment of the present disclosure, wherein the wear monitoring system comprises a group of three reflector strips arranged as a Target 1 in a first target portion, another group of three reflector strips arranged as a Target 2 in a second target portion, and a sensing assembly comprising sixteen sensing pairs;

FIG. 8A is a graph illustrating data compiled by the wear monitoring system of FIG. 7 after eight revolutions, wherein presence of a signal (i.e., negative signal intensity) indicates presence of the target portions (e.g. Target 1 and Target 2) and a splice of the conveyor belt;

FIG. 8B is an enlarge graph illustrating the data in rectangular area 8B in FIG. 8A;

FIG. 9 is a cross-sectional view of a target portion of a conveyor belt having two reflector strips embedded at various depths according to another embodiment of the present disclosure;

FIG. 10 is a top plan view of a wear monitoring system for a conveyor belt according to another embodiment of the present disclosure, wherein the wear monitoring system comprises a group of three reflector strips arranged as a Target 1 in a first target portion, another group of three reflector strips arranged as a Target 2 in a second target portion, and a group of two reflector strips arranged as a New Target, and a sensing assembly comprising sixteen sensing pairs; and

FIG. 11 is a graph illustrating wear progression of a target portion of a conveyor belt versus presence of a signal (i.e., negative signal intensity).

### DETAILED DESCRIPTION

The following description of technology is merely exemplary in nature of the subject matter, manufacture and use of one or more disclosures, and is not intended to limit the scope, application, or uses of any specific disclosure claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

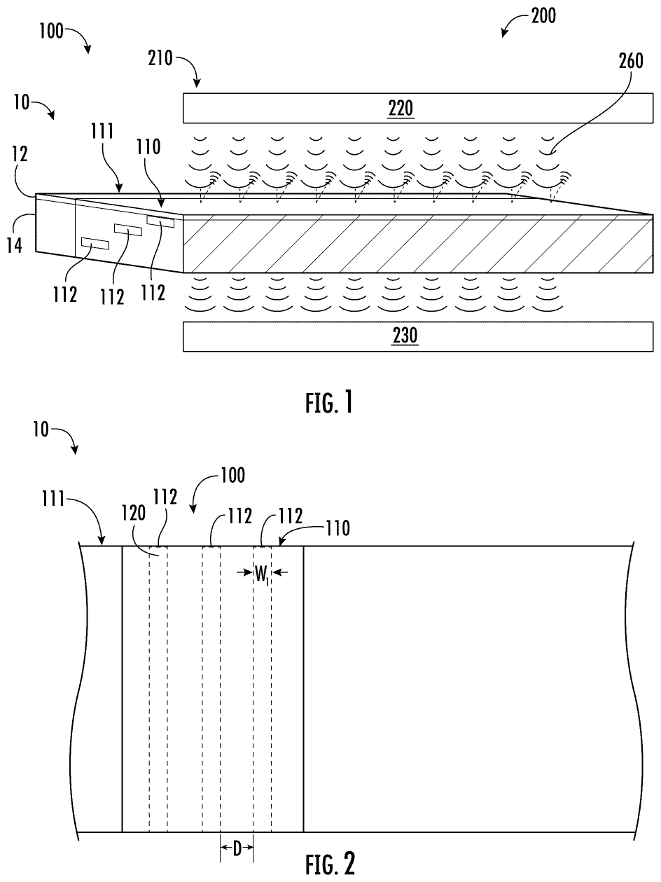

A monitoring system 100 for a conveyor belt 10 of the present disclosure is best understood with reference to FIGS. 1-11. The conveyor belt 10 may comprise one or more layers, for example, a cloth outer layer 12 covering one or more inner layers 14 produced from any number of elastomers, including natural rubbers, synthetic rubbers, and PVC. It should be appreciated, however, that the conveyor belt 10 may have any size (i.e., length, width, thickness), shape, configuration, and material composition as necessary for an operation thereof.

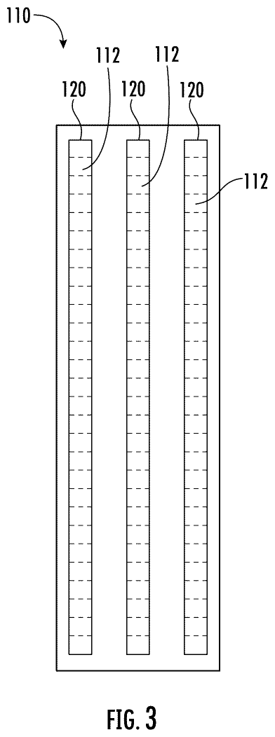

FIG. 1 illustrates a wear monitoring system 100 to monitor surface damage and wear of the conveyor belt 10 according to an embodiment of the present disclosure. The monitoring system 100 may comprise at least one target portion 110 of the conveyor belt 10 and a sensing assembly 200 including one or more sensing pairs 210. In the embodiment shown in FIGS. 1 and 2, the target portion 110 may be a separate insert provided with and/or integrated into the conveyor belt 10. In other embodiments, however, the target portion 110 may be integrally formed with a remainder portion 111 of the conveyor belt 10, if desired. In some instance, the target portion 110 has a width (traverse to a longitudinal direction of the conveyor belt 10) of about sixty inches. However, it is understood that the target portion 110 may have any width as desired.

As depicted, the target portion 110 may include one or more reflectors 112. The reflectors 112 may be disposed on and/or embedded within the target portion 110. It is understood that each of the reflectors 112 may be any type, size, and configuration of reflective elements. In certain embodiments, a plurality of the reflectors 112 are arranged in a linear configuration to form reflective strips 120. For ease of reference, the reflectors 112 may be referred to as the reflective strip 120, and such terms may be used interchangeably herein. In some embodiments, each of the reflectors 112 may be formed of a radio frequency absorbent and/or reflective material (e.g., a copper mesh fabric). However, it should be understood, however, that the reflectors 112 may be formed of any material that absorbs and/or reflects radio frequencies.

As more clearly shown in FIG. 2, a length of the reflective strip 120 may span at least partially across the target portion 10. It should be understood, however, that the length of the reflective strip 120 may span any distance across the target portion 110 as desired. In an embodiment of the present disclosure, the reflective strips 120 each may have a width W₁ of about two inches and a thickness in a range of about 0.003 inches to about 0.008 inches, but it should be understood that the reflectors 112 and/or the reflective strip 120, generally, may have any width W₁, and thickness as desired. Each of the reflective strips 120 may be horizontally spaced apart from an adjacent one of the reflective strips 120 by a distance D. In a non-limiting example, the distance D may be about three inches. It is understood, however, that the reflective strips 120 may be horizontally spaced apart from one another by any distance D as desired.

At least one of the reflectors 112 and/or at least a portion of the reflective strip 120 may also be perforated or cut across the width of the reflective strip 120 in segmented intervals, as shown in FIG. 3, to prevent a large portion of the reflective strip 120 from being inadvertently removed during operation of the conveyor belt 10. In an embodiment of the current disclosure, the reflective strip 120 may be perforated or cut across the width thereof at two-inch intervals over at least a portion of the length of the reflective strip 120. It should be appreciated, however, that the reflective strip 120 may be perforated or cut at any length intervals as desired over any portion or an entirety of the length thereof. In other embodiments, the reflective strip 120 may comprise be a linear array of spaced apart, smaller reflectors 112 rather than one long single reflective strip 120. An adhesive (not illustrated), such a solvated adhesive like a polymer, for example, may be applied to the reflective strip 120 in any suitable manner prior to the installation of the reflective strip 120 in the target portion 110. In this way, the reflective strip 120 may be fixedly embedded in the target portion 110. It should be appreciated, however, by one skilled in the art that the reflective strip 120 may be embedded or installed within the target portion 110 in any suitable manner.

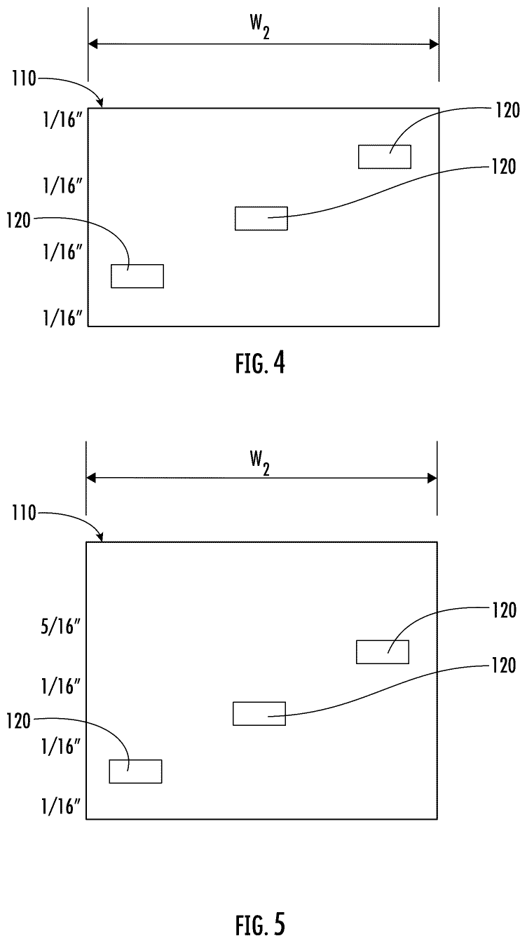

FIGS. 4 and 5 illustrate examples of the reflector strips 120 embedded within the target portion 110. As shown, the target portion 110 may have a width W₂ traverse to the longitudinal direction of the conveyor belt 10. In certain instances, the target portion 110 has a width W₂ in a range of about 12 inches to about 14 inches. However, it is understood that the target portion 110 may have any width W₂ as desire. In one embodiment, a plurality of the reflective strips 120 may be embedded in the target portion 110 and vertically staggered in depths relative to one another in the target portion 110 from a lower depth on one side to an upper depth on an opposing side thereof. The reflector strips 120 may be embedded within the target portion 110 at any depth as desired. In the embodiment shown in FIG. 4, the reflector strips 120 are embedded and vertically spaced from a top outer surface, a bottom outer surface, and from each other at about 1/16-inch increments when the top outer surface is being monitored for wear. In other embodiments shown in FIG. 5, a first of the reflector strips 120 may be embedded at a depth of about 5/16-inch from the top outer surface of the conveyor belt 10 when the top outer surface is being monitored for wear, instead of about 1/16-inch as illustrated in FIG. 4. As many reflector strips 120 may be used as desired, for example, three reflector strips 120 may be utilized. A plurality of reflector strips 120 embedded within the target portion 110 may be comprise a target 150. One or more targets 150 may be provided within the conveyor belt 10 and associated with the monitoring system 100.

These sample embodiments are provided for example and are not intended to be limiting. The reflector strips 120 may be embedded within the target portion 110 in any suitable manner and with any measurements.

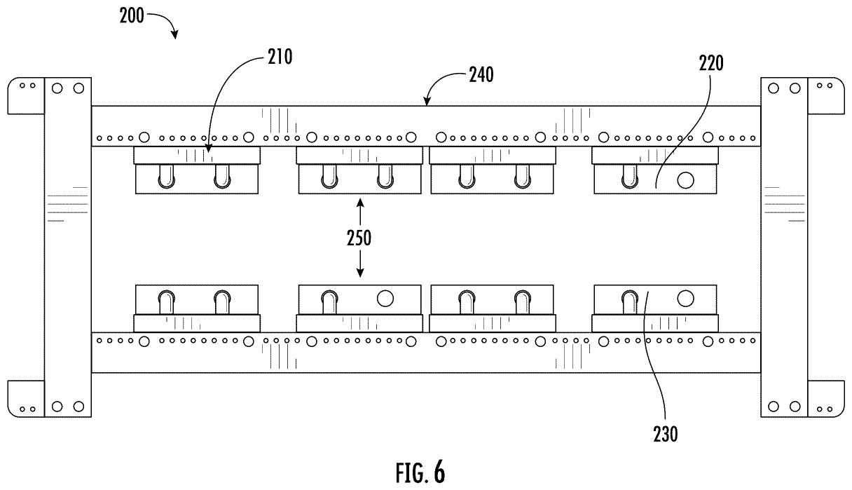

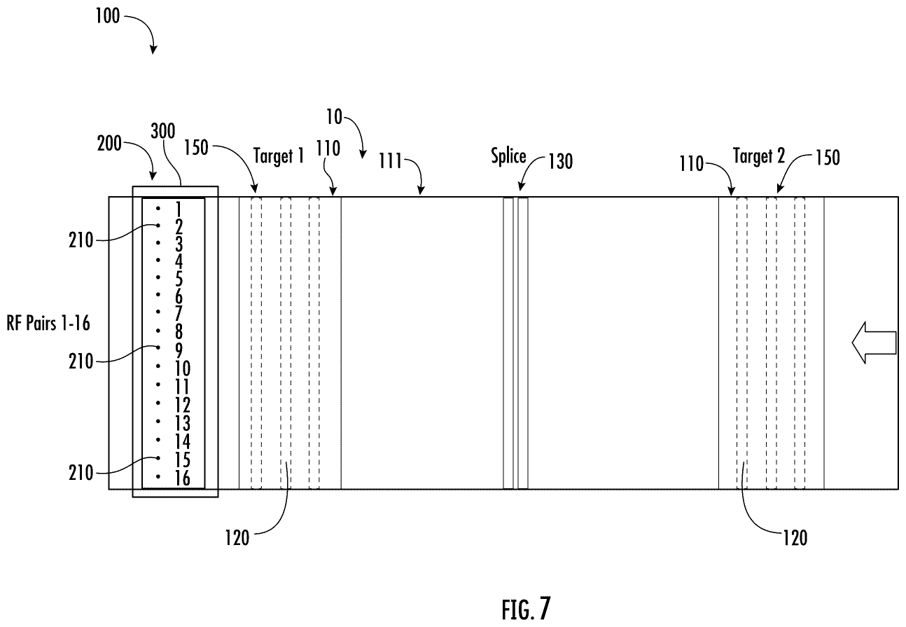

As illustrated in FIG. 6, each of the sensing pairs 210 of the sensing assembly 200 may comprise at least one transmitter 220 corresponding and aligned with at least one receiver 230. In certain embodiments, the sensing pairs 210 may be radio frequency (RF) pairs comprised of one or more radio frequency transmitters 220 and one or more radio frequency receivers 230. A mounting structure 240 may be provided for the sensing pairs 210. The sensing pairs 210 may be in electrical communication with one or more controllers 300 (depicted in FIG. 7). The controller 300 may include or be part of a data gathering system (not depicted) and/or a data filtering system.

In a preferred embodiment, the sensing assembly 200 includes sixteen sensing pairs 210, comprised of sixteen transmitters 220 and sixteen receivers 230. It should be understood that any number of transmitters 220 and receivers 230 may be employed in the sensing assembly 200, as desired. The transmitters 220 and the receivers 230 may be configured to be disposed opposite one another on the mounting structure 200. In certain instances, the transmitters 220 are coupled to a top portion of the mounting structure 240 and the receivers 230 are coupled to a bottom portion of the mounting structure 240. A space 250 is formed between the transmitters 220 and the opposite receivers 230 to receive the conveyor belt 10, and more particularly, the target portion 110, therethrough. The mounting structure 240 may be disposed adjacent the conveyor belt 10 so that the target portion 110, with the reflector strips 120 embedded therein, may cycle through the space 250 of the mounting structure 240. In preferred embodiments, the top outer surface of the conveyor belt 10 is being monitored for wear, and therefore, the transmitters 220 are located adjacent thereto. It should be understood that the mounting structure 240 may take any shape, size, and configuration as desired with more or less components, etc. than shown and described herein.

During operation, each of the transmitters 220 may generate and transmit a signal 260 (e.g., a radio frequency signal), shown in FIG. 1, which may be received by a corresponding one of the receivers 230 disposed opposite the transmitter 220 in the mounting structure 240. As the target portion 110 cycles through the space 250 of the mounting structure 240, the target portion 110 may be exposed to the signals 260 emitted and received by the sensing pairs 210. The signals 260 will not be interrupted by the conveyor belt 10, allowing for the signals 260 emitted by the transmitters 220 to be received by the receivers 230. However, the signals 260 may be at least partially absorbed and/or reflected by the material comprising the reflectors 112 when the reflector strips 120, which are embedded within the target portion 110, pass through the space 250 of the mounting structure 240 where the signals 260 are being transmitted and received. The reflectors 112 interrupt the signals 260 emitted by the transmitters 220. As such, an intensity of one or more of the signals 260 is decreased and a disruption is noted in the data that is being collected from the receivers 230 by the controller 300. The decrease in the intensity of the signals 260 and the disruption noted in the data collected indicates a presence of the reflectors 112, and/or the reflective strips 120, in the target portion 110. As the surface of the target portion 110 of the conveyor belt 10 wears, the reflectors 112 are worn away and/or pulled out of the target portion 110. When the reflectors 112 are no longer present within the target portion 110, the signals 260 are not interrupted and, therefore, the intensity of the signals 260 remains constant, which thereby provides a location and/or an extent of the wear of the target portion 110, and thereby the conveyor belt 10.

The controller 300 including the data gathering and retrieval system with an automated data filtering system may be used in order to collect and interpret the data provided by the sensing assembly 200 including the sensing pairs 210. An example of the data gathering and retrieval system with an automated data filtering system is described hereinbelow. However, it should be understood by one skilled in the art that any data gathering and retrieval method or system may be used in conjunction with the present disclosure. Additionally, any data filtering system, automated, semi-automated, and/or manual, may be used in conjunction with the invention.

An embodiment of the controller 300 including the data gathering and retrieval system with the data filtering system to be used with the embodiments disclosed herein. It should be noted that any controller 300 with the ability to process the data described may be used. The controller 300 may be a computing system, including at least one computing device, at least one processing device, at least one memory device, at least one circuit board, at least one hard drive, at least one power supply unit, at least one video card, and/or at least one optical drive. The controller 300 may receive the data from the sensing assembly 200 including the sensing pairs 210. In an embodiment, the sensing pairs 210 may be scheduled to run and collect data for a predetermined time interval (e.g., thirty-minute intervals). In some instances, a runtime of the sensing pairs 210 may be programed to be staggered so that only a certain number of the sensing pairs 210 run and collet data during each thirty-minute window, reducing the amount of accumulated raw data. Once the controller 300 receives the raw data, it is processed in any suitable manner. The data may be queued and stored in a database.

Automated scripts that are programmed to run on the on-board server execute at the predetermined time intervals to filter the raw data in the first database. The first automated script filters out all data points that are not the peak data points, i.e. the peak attenuation of the signals 260 through the target portion 110. These filtered results are stored into a second database (not illustrated). A second automated script extracts the data from the second database and sends it to a remote server (not illustrated) by cellular modem (not illustrated) for temporary storage. The peak attenuation data is downloaded to a local computer through the internet for analysis and reporting. A third automated script on the on-board server reformates the raw data and inserts it into a third database (not illustrated) for long-term storage.

This sample embodiment of the control including the data gathering and retrieval system with the automated data filtering system is provided for example and is not intended to be limiting. The data gathering and retrieval system with the automated data filtering system may take the form of any suitable system for the purposes described hereinabove.

FIG. 7 illustrates an exemplary conveyor belt 10 including the target portions 110 with the embedded reflector strips 120 forming the targets 150 and a splice 130. Specifically, there are two targets 150 comprised of the target portions 110, each of the target portions 110 having three reflector strips 120. Disposed between the targets 150 is the splice 130. The first target 150, located on a first end of the conveyor belt 10, is disposed on a first side of the splice 130. The second target 150, located on a second end of the conveyor belt 10, is disposed on a second side of the splice 130. The splice 130 may be comprised of a metal material or any suitable material and is intended to hold two segments and/or opposing ends of the conveyor belt 10 together. The splice 130 may interrupt the signal emitted by the transmitters 220 of the monitoring system 100, creating additional data points in the data set collected by the controller 300.

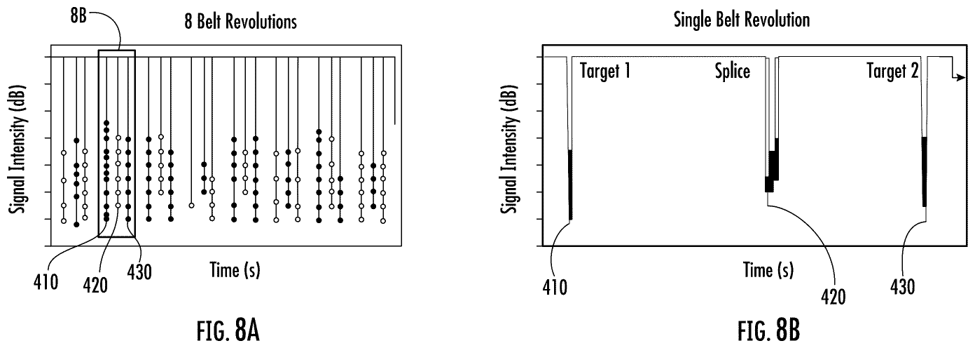

FIGS. 8A and 8B depict graphs illustrating the data taken from the monitoring system 100 fitting the structure of the embodiment described hereinabove. In each set, the data is from a pair of the sensing pairs 210. A first data spike 410 is a reading from the first target 150 comprised of one of the target portions 110, a second data spike 420 is a reading from the splice 130, and a third data spike 430 is from the second target 150 comprised of another one of the target portions 110.

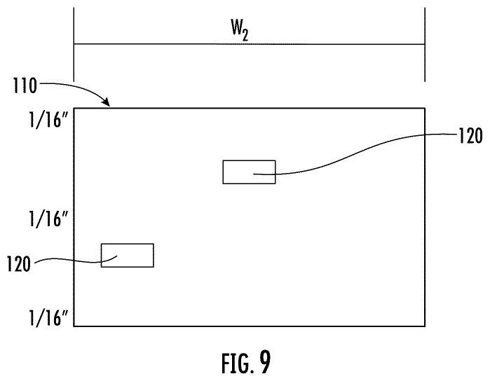

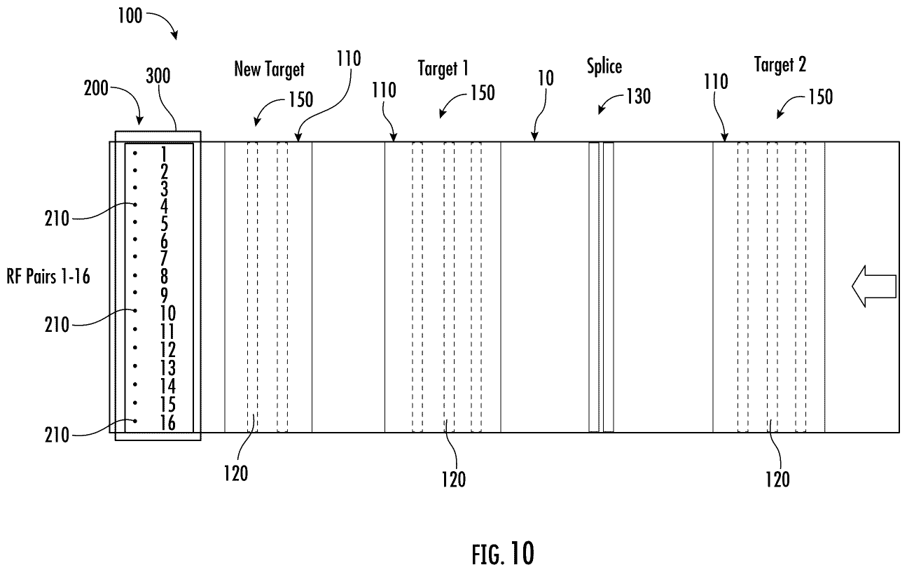

FIG. 9 illustrates another exemplary target portion 110 of the conveyor belt 10. As depicted, the target portion 110 has two reflector strips 120 spaced apart from the top outer surface, the bottom outer surface, and each other by 1/16 inch.

FIG. 10 illustrates the conveyor belt 10 including the target portions 110 with the embedded reflector strips 120 forming the three separate targets 150 and the splice 130 of the present disclosure in accordance with another embodiment. Two of the targets 150 are comprised of the target portions 110 having three reflector strips 120 and the third target 150 comprised of the target portion 110 having only two reflector strips 120. Disposed between the two targets 150, with the target portions 110 having three reflectors 120, is the splice 130. The first target 150, located on a first end of the conveyor belt 10, is disposed on a first side of the splice 130. The second target 150, located on a second end of the conveyor belt 10, is disposed on a second side of the splice 130. A new target 150 is disposed on a side of the first target 150 opposite the splice 130.

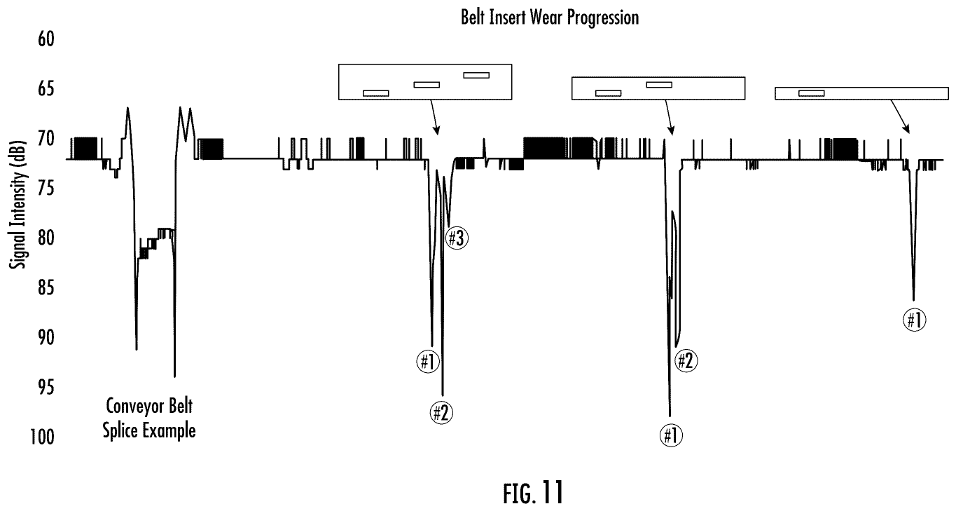

FIG. 11 illustrates a graph comparing wear of the target portions 110 to presence of the signals 260. As discussed hereinabove, the signals 260 will not be interrupted by the target portions 110, allowing for the signals 260 emitted by the transmitters 220 to be received by the receivers 230. However, the signals 260 may be at least partially absorbed and/or reflected by the material comprising the reflector 112 when the reflector strips 120, which are embedded within the target portions 110, pass through the space 250 of the mounting structure 240 where the signals 260 are being transmitted and received. When the reflectors 112 interrupt the receivers 230 from receiving the signals 260 emitted by the transmitters 220, an intensity of one or more of the signals 260 is decreased (i.e., negative signal intensity) and a disruption is noted in the data that is being collected from the receivers 230. The decrease in the intensity of the signals 260 and the disruption noted in the data collected indicates a presence of the reflectors 112 in the target portions 110. As the surface of the target portions 110 wears, the reflectors 112 are worn away and/or pulled out of the target portions 110. When the reflector strips 120 are no longer present within the target portions 110, the signals 260 are not interrupted and, therefore, the intensity of the signals 260 remains constant, which thereby provides a location and/or an extent of the wear of the conveyor belt 10. As shown, the target portions 110 having three reflector strips 120 provides three distinct peaks of negative signal intensity (See #1, #2, and #3). As the target portions 110 wear, the reflectors 112 are worn away and/or pulled out of the target portions 110, which is depicted in the data by less peaks of negative signal intensity. For example, the target portions 110 may wear to two reflector strips 120, which results in two peaks of negative signal intensity (See #1 and #2), and then wear to one reflector strip 120, which results in only one peak of negative signal intensity (See #1). Additionally, FIG. 11 illustrates a difference between the negative signal intensity resulting from the splice 130 versus the negative signal intensity resulting from the targets 150.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A conveyor belt insert, comprising:
at least one layer; and
a plurality of reflectors disposed in the at least one layer, wherein the reflectors are configured to alter a signal transmitted from a monitoring system configured to detect surface wear of a conveyor belt, and wherein the reflectors are disposed at various depths within the at least one layer relative to an outer surface of the conveyor belt.

2. The conveyor belt insert of claim 1, wherein the reflectors are produced from a radio frequency absorbent material and/or a reflective material.

3. The conveyor belt insert of claim 1, wherein the reflectors are produced from a copper mesh fabric.

4. The conveyor belt insert of claim 1, wherein the reflectors span at least partially across a width of the conveyor belt.

5. The conveyor belt insert of claim 1, wherein at least a portion of the reflectors are arranged in a linear configuration to form one or more reflective strips.

6. The conveyor belt of claim 5, wherein each of the reflective strips are spaced apart from an adjacent one of the reflective strips.

7. The conveyor belt of claim 5, wherein at least a portion of at least one or the reflective strips may be perforated and/or cut across a width thereof in segmented intervals.

8. The conveyor belt of claim 5, wherein at least one of the reflective strips is comprised of a linear array of spaced apart reflectors.

9. The conveyor belt of claim 5, wherein the reflective strips are vertically spaced apart from one another within the at least one layer.

10. A wear monitoring system for a conveyor belt, comprising:
at least one target portion provide with the conveyor belt, wherein the target portion includes at least one layer having one or more reflectors disposed at various depths within the at least one layer relative to an outer surface of the conveyor belt; and
a sensing assembly disposed adjacent to the at least one target portion, wherein the wear monitoring system is configured to detect surface wear of the conveyor belt.

11. The wear monitoring system of claim 10, wherein a generally constant intensity of a signal emitted by the sensing assembly indicates surface wear of the conveyor belt.

12. The wear monitoring system of claim 10, wherein a decrease in intensity of a signal emitted by the sensing assembly indicates a presence of the one or more reflectors.

13. The wear monitoring system of claim 10, wherein the at least one target portion includes at least two reflective strips formed by the one or more reflectors.

14. The wear monitoring system of claim 10, wherein at least two target portions are provided with the conveyor belt.

15. The wear monitoring system of claim 10, wherein the sensing assembly includes one or more sensing pairs, each of the sensing pairs including at least one transmitter and at least one receiver.

16. The wear monitoring system of claim 15, wherein the at least one transmitter is disposed adjacent an outer surface of the conveyor belt.

17. The wear monitoring system of claim 15, wherein the at least one receiver is disposed adjacent the conveyor belt opposite the at least one transmitter.

18. The wear monitoring system of claim 15, wherein the at least one transmitter is configured to emit one or more signals and the at least one receiver is configured to receive the one or more signals emitted by the transmitter.

19. The wear monitoring system of claim 15, wherein the one or more sensing pairs are radio frequency pairs comprised of at least one radio frequency transmitter and at least one radio frequency receiver.

20. A method of monitoring surface wear of a conveyor belt, comprising:
providing a wear monitoring system comprising at least one target portion provided with the conveyor belt and a sensing system, wherein the sensing system comprises at least one sensing pair including at least one transmitter and at least one receiver;
emitting one or more signals from the at least one transmitter;
receiving by the at least one receiver the one or more signals from the at least one transmitter; and
determining a surface wear of the conveyor belt based upon an intensity of the one or more signals.
